(19) United States
(12) Patent Application Publication
(10) Pub. No.: US 2013/0160144 A1
(43) Pub. Date: Jun. 20, 2013

(54) ENTITY VERIFICATION VIA THIRD-PARTY

(71) Applicants: Yi Lang Mok, Bellevue, WA (US); Jonathan Michel Garcia, Duvall, WA (US)

(72) Inventors: Yi Lang Mok, Bellevue, WA (US); Jonathan Michel Garcia, Duvall, WA (US)

(73) Assignee: Microsoft Corporation, Redmond, WA (US)

(21) Appl. No.: 13/325,400

(22) Filed: Dec. 14, 2011

(51) Int. Cl. G06F 21/00

(52) U.S. Cl. 726/29

(57) ABSTRACT

Among other things, one or more techniques and/or systems are provided for verifying an identity of an entity via a third-party authentication system. As an example, an entity may be logged into a website and may have certain access permissions given the manner within which the entity was logged into the website. The entity may attempt to access, via the website, protected data owned by the website and/or owned by a third-party (e.g., social networking website). If the access permissions presently associated with the entity do not allow the entity to access the protected data, a request may be made to the third-party authentication system (e.g., operated by the social networking website) to verify the identity of the entity before increasing the access permissions to grant the entity access to the protected data.

### BACKGROUND

Today, many websites store personal information about entities (e.g., users). For example, shopping websites often store the shipping address, billing address, shopping trends, and/or credit card information of a user to facilitate a faster checkout experience for the user. Social networking websites often comprise private messages between entities and/or contact information of an entity. Bank websites may comprise information about the bank accounts associated with an entity.

An entity may become dissatisfied with a company (e.g., and may close their account with the company) if private information becomes accessible to unauthorized entities. Therefore, to protect private data that is stored by websites and/or other applications, many websites and/or other applications require some form of authentication. Such authentication typically comprises a username and/or password, although other authentication techniques are sometimes used. For example, an authentication server may compare an IP address, a Mac address, and/or information stored on a computer (e.g., an authentication cookie(s) previously given to the computer by the authentication system) to information known about an entity (e.g., and/or about a computer from which the entity accesses the website) to authenticate and/or re-authenticate the entity.

Generally, websites that store private data rely upon their own authentication system to authenticate an entity. Therefore, the entity typically creates a username and password for respective websites and/or other applications where personal information is to be stored. While the entity may attempt to use the same username and/or password for a plurality of websites and/or other applications, it will be appreciated that websites and/or other applications may have different requirements for the username and/or password. For example, websites may vary the minimum number of characters permissible for a username and/or password and/or may vary the type of characters permissible for a username and/or password. Additionally, some websites may, by default, set the username to be an email address associated with the entity while other websites may not allow an email address to be the username. Some websites may also require password updates periodically while other websites may not have such requirements. Thus, entities often have a plurality of usernames and/or passwords that they have to manage, and are forced to remember which usernames and/or passwords are associated with which website.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for accessing data (e.g., stored in association with a first website (e.g., stored in a database associated with the first website)) using a third-party authentication system (e.g., associated with a second website) are provided. As an example, a search engine website may utilize an authentication system of a social networking website to authenticate an entity for the search engine website (e.g., log the entity into the search engine website).

The third-party authentication system may also be utilized (e.g., by the first website) to grant the entity access to various types of data stored in association with the first website. By way of example, when an entity is initially logged into the search engine website via an authentication system of the social networking website, for example, the search engine website may associate low-level access permissions with the entity, which may grant the entity access to some (e.g., but not all) data associated with the entity. For example, the search engine website may grant the entity access to web crawl data and/or other low business impact (LBI) data while restricting access to more private information associated with the entity, such as general PII, address, phone number, internet protocol (IP), email, and/or other medium business impact (MBI) data. If the entity indicates an intention to access the MBI data and/or other data that is inaccessible given the low-level access permissions associated with the entity, the search engine website may use the third-party authentication system (e.g., authentication system of the social networking website) to verify an identity of the entity. When the identity of the entity is verified via the third-party authentication system, the search engine website may associate higher-level access permissions with the entity, which grant the entity access to the data that the entity intended to access (e.g., which was inaccessible when merely low-level access permissions were associated with the entity).

In one embodiment, the database associated with the first website, for example, may also store third-party data (e.g., belonging to and/or owned by a third-party) that is associated with the third-party authentication system. For example, the search engine website may store data associated with the social networking website (e.g., such as data indicative of friends' birthdays, data indicative of friends' addresses, etc.). To improve security (e.g., and maintain strong business relations with the third-party), the search engine website may verify the identity of an entity when a request to access third-party data via the search engine website is received from the entity. For example, in one embodiment, when such an intention is received, the search engine website may transmit a verification request to the third-party authentication system requesting a third-party access token (e.g., key). If the third-party authentication system responds to the verification request with the third-party access token, the search engine website may provide the requested third-party data. Otherwise, the search engine website may deny the request from the entity.

It will be appreciated that while specific reference is made herein to websites and/or databases/authentication systems associated with websites, the scope of the disclosure, include the scope of the claims, is not to be so limited. For example, applications (e.g., such as computer applications, mobile phone applications, etc.) may also provide private data to an entity and may utilize an authentication system to protect the private data. Thus, the scope of the disclosure is intended to include, among other things, applications and/or other software/hardware that utilizes authentication systems to authenticate an entity prior to accessing at least some data.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an exemplary method for providing an entity with access to private data.

FIG. 2 is an exemplary method for verifying an identity of an entity using a third-party authentication system.

FIG. 3 is an exemplary method for verifying an identity of an entity using a third-party authentication system.

FIG. 4 is an exemplary system for verifying an identity of an entity using a third-party authentication system.

FIG. 5 is an illustration of an exemplary computer-readable medium wherein processor-executable instructions configured to embody one or more of the provisions set forth herein may be comprised.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Among other things, one or more systems and/or techniques are provided for utilizing a third-party authentication system to authenticate an entity and/or to verify an identity of the entity while the entity is attempting to access private data (e.g., secured data, protected data, limited data, restricted data, etc.). For example, in one embodiment, an entity may be logged into a first website and low-level access permissions may be associated with the entity based at least in part upon the entity being presently and/or previously logged into a second website (e.g., the authentication of the entity by the second website grants the entity access to the first website (e.g., managed and/or controlled by a different entity (e.g., a different corporation) than the first website)). Such low-level access permissions may grant the entity access to some data stored in association with the first website, but access to other data (e.g., more private data, such as MBI data) may be limited.

Techniques for providing access to the limited data may be dependent upon, among other things, the type of data attempting to be accessed by the entity. As an example, the first website may store data owned by itself and/or third-party data (e.g., owned by a second website). When the entity makes a request to access limited (e.g., restricted) data that is owned by the first website, the first website may make a verification request to a third-party authentication system requesting verification information to verify an identity of the entity.

Typically, the verification request is configured to comprise information that allows (e.g., is sufficient to allow) the third-party authentication system to verify the identity of the entity without having to re-contact the entity (e.g., or a computing system associated with the entity). As an example, as part of constructing the verification request, the first website may acquire information about the entity from one or more authentication cookies stored by the third-party authentication system in a computing system associated with the entity. In other embodiments, the third-party authentication system may contact the entity and/or a computing system associated with the entity as part of the verification process.

If, in response to the verification request, the third-party authentication system provides the requested verification information (e.g., verifying the identity of the entity), the entity may be associated with higher-level access permissions that grant the entity access to the limited (e.g., restricted) data owned by the first website. If, instead, the third-party authentication system denies the request and/or indicates in a response that it cannot verify the identity of the entity, the first website may deny the entity access to the limited (e.g., restricted) data owned by the first website. Moreover, in one embodiment, if the third-party authentication system denies the request and/or indicates in a response that it cannot verify the identity of the entity, the first website may log the entity out of the first website (e.g., revoking even low-level access permissions until the entity re-authenticates itself).

When the entity makes a request, via the first website, to access limited (e.g., restricted) third-party data (e.g., as opposed to data owned by the first website) stored in association with the first website (e.g., such that it can be presented to the entity via the first website), the first website may make a verification request to the third-party authentication system requesting verification information to verify an identity of the entity. Such a verification request may comprise different information than a verification request made in response to the entity making a request to access limited (e.g., restricted) data owned by the first website and/or the request may seek a different type of response from the third-party authentication system. For example, the verification request may comprise a request for a third-party access token that provides the first website with access to the limited (e.g., restricted) data and/or specifies permissions for the third-party data.

If, in response to the verification request, the third-party authentication system provides the requested verification information (e.g., verifying the identity of the entity and/or providing the third-party access token), the entity may be granted access to the third-party data that is stored in association with the first website (e.g., and presented via the first website). If, instead, the third-party authentication system denies the request and/or indicates in a response that it cannot verify the identity of the entity, the first website may deny the entity access to the third-party data. Moreover, in one embodiment, if the third-party authentication system denies the request and/or indicates in a response that it cannot verify the identity of the entity, the first website may log the entity out of the website (e.g., revoking access permissions until the entity re-authenticates itself via an authentication system associated with the first website and/or via the third-party authentication system).

It will be appreciated that while specific reference is made herein to websites, the disclosure, including the scope of the claims, is not intended to be limited as such to the extent practicable. That is, the techniques and/or systems described herein may be utilized in conjunction with other resources besides websites. For example, applications, operating systems, and/or other software/hardware systems may limit access to some data/information and/or may utilize authentication systems to authenticate an entity prior to providing the entity with some information. Thus, to the extent practicable, the systems and/or techniques described herein may be utilized by, among other things, these applications, operating systems, and/or other software/hardware systems as well. Moreover, it will be appreciated that the phrase “third-party authentication system” and/or the like is used herein in a broad sense to describe an authentication system that is controlled by an entity other than the entity storing the data that is being requested.

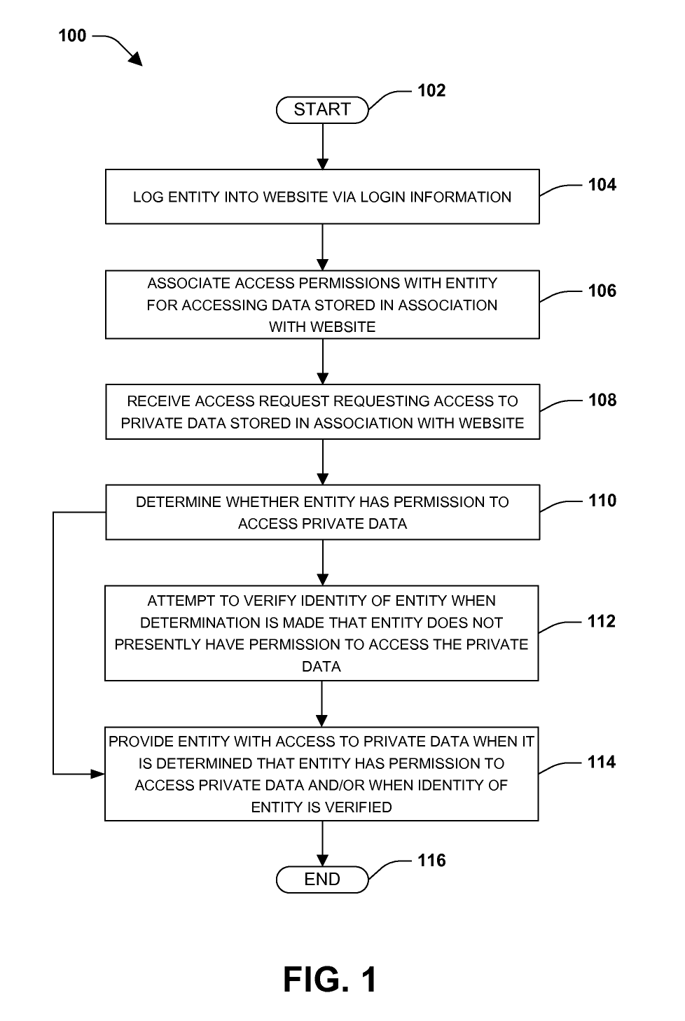

FIG. 1 illustrates an example method 100 for granting an entity access to private data (e.g., based upon verification of an identity of the entity via a third-party authentication system). The example method 100 begins at 102 and an entity is logged into a first website and/or other software/hardware system (e.g., herein collectively referred to as a website) at 104. The entity may log into the website directly using an authentication system provided by the website (e.g., an authentication portion of the website) and/or may log into the website via information supplied by the third-party authentication system. Stated differently, in essence, there may be at least two techniques through which an entity may authenticate itself to gain access to private content (e.g., that is not made publically available via the first website). The first technique utilizes an authentication system controlled by the first website and the second technique utilizes authentication information provided at least in part via a third-party authentication system (e.g., associated with a different website).

As an example of authenticating the entity (e.g., logging the entity in) via the first technique, an entity may access a website that authenticates the entity. For example, the website may provide an authentication mechanism, such as username and/or password entry fields where the entity can enter access credentials. If the entered access credentials match stored access credentials, the website may grant the entity access to at least some of the private content. If the entered access credentials do not match stored access credentials, the website may deny the entity access. It will be appreciated that while specific reference is made herein to an authentication mechanism that uses a username and/or password to authenticate, other tools may be used to authenticate an entity and are contemplated herein. For example, in another embodiment, the entity may be authenticated based upon a cookie given to the entity (e.g., or a computing system associated with the entity) by an authentication system associated with (e.g., controlled by) the website.

As an example of authenticating an entity via the second technique, a website that the entity is presently accessing may determine that the entity is logged into a second website managed by a third-party authentication system (e.g., an authentication system used by the second website to authenticate the entity for the second website), based upon information stored on a computing system associated with the entity (e.g., such as an authentication cookie(s)), and may log the entity into the website based upon such a determination. In another embodiment, the entity may not be presently logged into the second website but may have been previously logged into the second website such that authentication information was transmitted to the entity (e.g., or a computing system associated with the entity) that has not yet expired and/or otherwise been rendered ineffective for logging an entity into the second website. Thus, the entity may be authenticated by the website based upon an authentication by the website and/or an authentication by a second website (e.g., which may be managed/controlled by a different entity than the website).

At 106 of the example method 100, access permissions for accessing data stored in association with the website are associated with the entity. The access permissions are configured to provide instructions regarding what information the entity may access and/or regarding limitations on what information the entity may access. The access permissions that are assigned may be dependent upon, among other things, the authentication technique utilized to log the entity into the website. For example, higher-level access permissions may be assigned by default to the entity that authenticates via the website than may be assigned by default to the entity that logs in via a third-party authentication system. As an example, in one embodiment, when the entity logs in via the third-party authentication system, low-level access permissions may be assigned to the entity by default and when the entity authenticates via an authentication system associated with the website, higher-level access permissions may be associated with the entity. Moreover, higher-level access permissions may be associated with the entity when the entity authenticates on the website via a username/password than when an entity authenticates on the website via information stored on a computing system associated with the entity, for example.

As described above, the access permissions are configured to provide instructions regarding what information the entity may access and/or regarding limits on what information the entity may access given the present access permissions of the entity. For example, higher-level access permissions may grant the entity access to private information that the entity is denied from accessing when the entity is associated with low-level access permissions. As an example, a website may classify user data stored in association therewith (e.g., stored in servers associated with the website) into two or more categories, with access to data associated with respective categories limited based upon the access permissions assigned to the entity. As an example, a low business impact (LBI) category may comprise data that, while private, would be unlikely to cause an immediate business impact if such data were inadvertently made publically accessible, a medium business impact (MBI) category may comprise data that would likely cause an immediate business impact if such data were inadvertently made publically accessible, and a high business impact (HBI) category may comprise data that, if made publically accessible, would require compensation to be immediately made to the entity whose data was inadvertently made public (e.g., such as credit monitoring services). By way of example, LBI data may relate to web crawl data and/or data indicative of searches an entity has performed, MBI data may relate to an address, phone number, IP address, email, etc. of an entity, and HBI data may relate to a social security number, bank account, and/or credit card number of an entity. Thus, the private content that the entity can access may depend upon, among other things, access permissions that are associated with the entity.

At 108 in the example method 100, an access request requesting access to private data stored in association with the website is received. By way of example, an entity may desire to update its account information and thus may select a link directing the entity to a webpage of the website where the entity can update such information. In response to such a selection, a request may be generated that is received by the website (e.g., or a server thereof) requesting access to the account information.

At 110 in the example method 100, a determination is made whether the entity (e.g., that selected the link and/or made the request) presently has permission to access the requested private data. That is, stated differently, the website (e.g., or a system associated therewith) may determine whether the entity has permission to access the requested private data based upon the access permissions associated with the entity at 106. As an example, if the entity was logged into the website at 104 via login information supplied by a third-party authentication system and/or the entity was associated with low-level access permission at 106, it may be determined that the entity does not have permission to access the requested private data at 110 if the access request comprises a request to access private data that has been categorized as MBI data (e.g., because low-level access permissions, which may be assigned to the entity by default when the entity is logged in based upon login information supplied by the third-party authentication system may be inadequate to grant access to MBI data). Conversely, where the access request merely comprises a request to access private data that has been categorized as LBI data, it may be determined that the entity has permission to access the requested private data when merely low-level access permissions are associated with the entity. Thus, the determination regarding whether the entity has permission to access the requested private data may depend upon, among other things, the permissions that have been associated with the entity and/or the permissions that have been specified to allow an entity to access the requested private data.

The determination made at 110 may also depend upon, among other things, who owns the requested private data that is being requested. For example, in one embodiment, the website and/or databases associated with the website may store third-party data (e.g., a third-party may own the data), and the entity may not have permission to access the third-party data until a third-party access token is acquired from the third-party authentication system, for example. When, the private data that is being requested is owned by the website itself, the entity may have permission to access the private data so long as the entity has the correct permissions levels (e.g., and an access key provided by a third-party may not be needed).

At 112 in the example method 100, when a determination is made at 110 that the entity does not presently have permission to access the requested private data (e.g., because the permissions presently associated with the entity are not sufficient and/or a third-party access token is required), an attempt to verify an identity of the entity may be made so that the entity can access the data that the entity presently does not have permission to access.

As will be described below in more detail, how the identity of the entity is attempted to be verified may depend upon, among other things, how the entity was logged in at 104 and/or the type of private data that is being requested at 108. For example, if the entity was authenticated at 104 via the website that the entity is presently attempting access the private data through, the website may request that the entity enter additional login information (e.g., such as a pin) to verify the identity of the entity. That is, the website may comprise an additional authentication process that may be used when the entity attempts to access more sensitive data, such as bank accounts and/or credit cards numbers, for example, that require higher-level permissions than those presently associated with the entity.

If the entity was authenticated at 104 via the third-party authentication system and/or if the entity is requesting access to data owned by a third party that is stored in databases associated with the website, verifying the identity of the entity may involve contacting the third-party authentication system to request verification information to verify the identity of the entity. In this way, the third-party authentication system may provide the website with verification information (e.g., a third-party access token, an entity confirmation, etc.) that may be used by the website to grant the entity access to the requested data.

At 114 in the example method 100, the entity is provided with access to private data requested via the access request when it is determined at 110 that the entity has permission to access the private data and/or when an identity of the entity is verified at 112. It will be appreciated that if it was determined at 110 that the entity does not have permission to access the requested data and/or if the identity of the entity is unable to be verified at 112, the access request received at 108 may be denied and/or the entity may be forced to re-authenticate (e.g., via the website), for example.

At 116, the example method 100 ends.

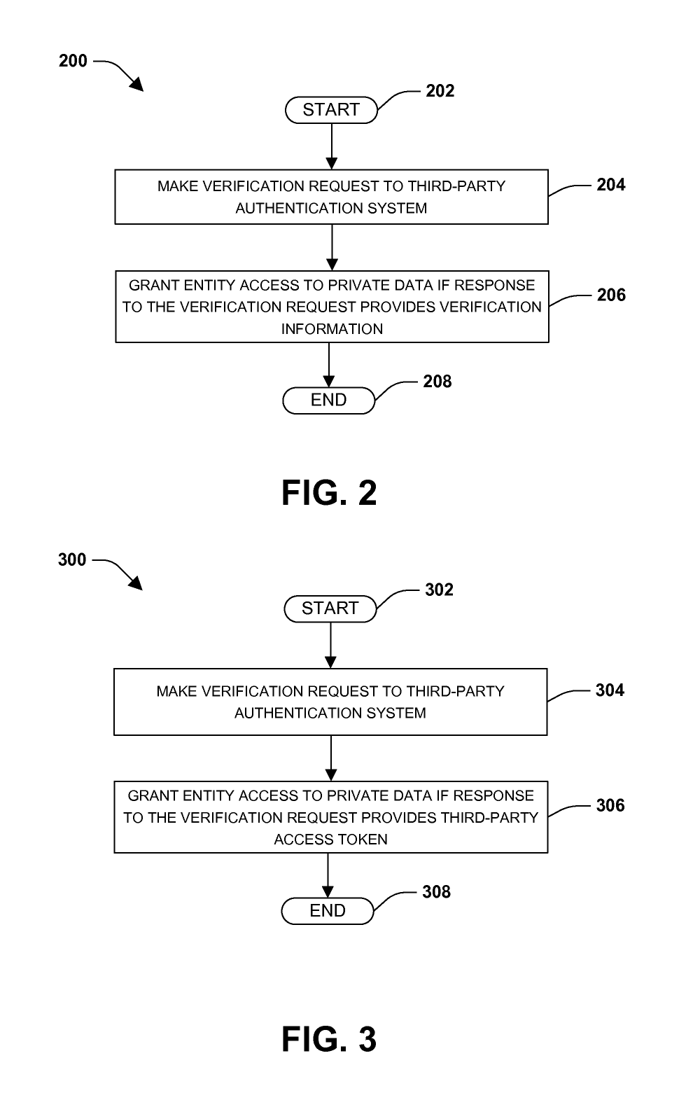

FIG. 2 illustrates an example method 200 for verifying the identity of an entity (e.g., 112 in the example method 100 of FIG. 1) via a third-party authentication system when an access request, requesting access to private data owned by the entity (e.g., website and/or associated database), is received from the entity. As an example, such a method 200 may find applicability in environments where a website, for example, permits an entity to log into the website based upon login information provided by a third-party authentication system. That is, stated differently, the example method 200 finds applicability in environments where an entity is (automatically) logged into a website based at least in part upon the entity presently and/or previously being logged into another website (e.g., not controlled by the same entity as the entity/website receiving the access request). By way of example, an entity may be automatically logged into a search engine website based upon the entity presently and/or previously being logged into a social networking website (e.g., the entity enters login credentials into the social networking website and the entity is authenticated via the social networking website for the search engine website).

As described above, when an entity is logged into a website based upon authentication information supplied by a third-party authentication system (e.g., based upon a cookie associated with a social networking website), the website and/or an authentication system thereof may associate low-level access permissions with the entity by default because the website did not authenticate the entity via its own authentication system. Thus, if the entity attempts to access private data that is accessible merely with higher-level access permission, access to the private data may be denied unless the identity of the entity can be verified. In this way, the website protects the private data from being inadvertently released based upon a faulty/expired third-party authentication, for example.

The example method 200 begins at 202, and a verification request is made to the third-party authentication system at 204. Typically, such a verification request is made when the entity attempts to access data that the entity does not have permission to access (e.g., given the low-level access permissions associated with the entity). However, the verification request may be triggered by other events.

Generally, the verification request may comprise, among other things, information about the entity (e.g., or a computing system from which the entity is accessing the website) and/or a request for verification information about the entity. Such information about the entity may be acquired from, among other things, cookies stored in a computing system used by the entity to access the website, hardware identification information (e.g., mac address) of the computing system, an IP address associated with the entity, and/or other information that may be useful to a third-party authentication system to verify the identity of the entity. As an example, when the website is unable to verify the identity of the entity itself (e.g., and thus uses a third-party authentication system to verify the identity), the website may search a computing system of the entity to identify information (e.g., specified by the third-party authentication system) that the third-party authentication system may use to verify the identity of the entity and/or may compile the identified information into a verification request that may be transmitted to the third-party authentication system. In this way, the verification request may comprise information that is configured to be utilized by the third-party authentication system to reevaluate a user authentication key, for example, that was issued to the entity (e.g., to allow the entity to be logged into a website managed by the third-party authentication system and/or logged into the website making the verification request).

It will be appreciated that the verification request may be transmitted to the third-party authentication system via numerous techniques and/or channels. For example, in one embodiment, a secure connection may be established between the website and the third-party authentication system for transmitting one or more packets comprising the verification request and/or for transmitting verification information provided by the third-party authentication system. In another embodiment, such a connection may be unsecure.

It will also be appreciated that the information comprised in the verification request, the manner through which the verification request is made, and/or the manner through which the verification request is transmitted to the third-party authentication system may be a function of, among other things, an authentication protocol used by the third-party authentication system. For example, in one embodiment, the third-party authentication system uses an OAuth authentication protocol and the verification request is made and/or transmitted in compliance with standards for the OAuth authentication protocol. In other embodiments, other authentication protocols may be utilized, and thus the information comprised in the verification request and/or the manner through which such information and/or request is transmitted may vary.

At 206 in the example method 200, access to the private data is granted to the entity if a response to the verification request provides the verification information (e.g., 114 in the example method 100 of FIG. 1). That is, stated differently, if the third-party authentication system provides the website (e.g., or an authentication system thereof) with verification information that is configured to (e.g., sufficient to) verify the identity of the entity, the website may grant the entity access to the private data that the entity was unable to previously access. As an example, upon verification, the website may be configured to associate the entity with higher-level access permissions than the entity was associated with prior to making the verification request at 204. By changing such access permissions, the entity may, in turn, be granted access to data that required the higher-level access permissions (e.g., which the entity did not have permission to access prior to the change in access permissions). Thus, the verification information may be utilized to directly grant an entity access to the private data and/or may be utilized to alter the access permissions (e.g., which, in turn, causes the entity to be granted access to the private data).

It will be appreciated that, as an added security measure, data that the entity gains access to upon the verification may be transmitted to the entity via a secured connection (e.g., HTTPS) and/or an unsecured connection. For example, in one embodiment, upon the verification of the identity of the entity, a secure connection may be established between the website and a computing system associated with the entity, and at least a portion of the data transmitted between the website and the computing system may be transmitted via the secure connection. In this way, more sensitive information (e.g., to which the entity gained access once the identity of the entity was verified) may be transmitted via a connection that provides additional security features to protect the data (e.g., relative to an unsecure connection that the entity may have initially used to connect to the webpage), for example.

It will be appreciated that in one embodiment, the example method 200 may be carried out with the entity having little to no knowledge of the verification that is occurring at 204 and 206. As an example, in one embodiment, the information stored in the computing system associated with the entity may be sufficient to make the verification and/or the entity may not be required to enter additional verification information. Moreover, such verification may occur in real-time as the entity is attempting to access the private data that is presently inaccessible by the entity, and the entity may be unaware that the present access permissions of the entity are insufficient to access such data (e.g., although a computing system associated with the entity may be aware if information is retrieved from the computing system as part of making the verification request).

In another embodiment, as part of making the verification request and/or as part of verifying the identity of the entity (e.g., by the third-party authentication system), the entity may be prompted to enter additional verification information (e.g., such as a password and/or pin number) by the website and/or by the third-party authentication system. Thus, in such an embodiment, the entity may be notified of the verification process and/or may participate in the verification process.

The example method 200 ends at 208.

As described with respect to FIG. 1, in some environments, a website may store third-party data (e.g., owned by another website and/or other application). For example, a website may store data related to friends of an entity, such as their respective birthdays, email addresses, etc. that are acquired from data owned by a social networking website. Such third-party data, while stored in databases associated with the website, is not owned by the website. Therefore, when an access request is received by the website indicative of an intention to view (e.g., on the website) the third-party data, additional and/or different security protections, relative to those described with respect to FIG. 2, may be taken by the website to verify the identity of the entity prior to fulfilling such an access request. Failure to take such precautions might strain business relations between the two websites, for example, as the website that owns the data may not desire to continue sharing data with the website storing/presenting the data if such data is inadvertently released to the public and/or to an imposter (e.g., hacker).

FIG. 3 illustrates an example method 300 for verifying the identity of an entity (e.g., at 112 in the example method 100 of FIG. 1) via a third-party authentication system when an access request, requesting access to third-party data stored by the website attempting to verify the identity of the entity, is received. As an example, such a method 300 may find applicability in environments where a website, for example, permits an entity to log into the website based upon login information provided by a third-party authentication system and/or is configured to present to the entity third-party data. By way of example, an entity may be automatically logged into a search engine website based upon the entity presently and/or previously being logged into a social networking website (e.g., the entity enters login credentials into the social networking website and the entity is authenticated via the social networking website to the search engine website). Moreover, the search engine website may be configured to present at least some of the data owned by the social networking website (e.g., originally input into the social networking website as opposed to the search engine website).

The example method 300 begins at 302, and a verification request is made to the third-party authentication system at 304. Typically, such a verification request is made when the entity attempts to access the data owned by another website and an access request is generated in response thereto. However, the verification request may be triggered by other events. For example, in another embodiment, the trigger may be the entity being logged into a website. As an example, upon an entity accessing the website, the website may create a verification request requesting a third-party access key and transmit the verification request to the third-party authentication system. In this way, the website may receive a third-party access key prior to an access request, requesting access to third-party content (e.g., stored on databases associated with the website) being received, for example.

Generally, the verification request may comprise, among other things, information about the entity (e.g., or a computing system from which the entity is accessing the website) and/or a request for verification information about the entity, including a request for a third-party access token. Generally, an access token is generated by the third-party authentication system when the entity logs into the third-party authentication system (e.g., logs into the website controlling the third-party authentication system) and the credentials supplied by the entity are authenticated against authentication data stored in the third-party authentication system. Rights of the entity (e.g., as specified by the third-party authentication system) are typically specified in a security descriptor enclosed by the token. Thus, because the access request is for third-party content, the website receiving the access request may request the access token to determine whether the entity has permission, from the third-party, to access the third-party content stored on the website.

Other information that may be included in the verification request includes, but is not limited to, cookies stored in a computing system associated with the entity, hardware identification information (e.g., mac address) of the computing system, an IP address associated with the entity, and/or other information that may be useful to a third-party authentication system to verify the identity of the entity prior to issuing the third-party access token to the website. In this way, the verification request may comprise information that is configured to be utilized by the third-party authentication system to verify the identity of the entity prior to providing the website with the third-party access token granting the entity access to the requested information (e.g., providing the third-party authentication system with added protection so that the third-party authentication system can verify, for itself, that the entity is indeed permitted to access the data).

It will be appreciated that the verification request may be transmitted to the third-party authentication system via numerous techniques and/or channels. For example, in one embodiment, a secure connection may be established between the website and the third-party authentication system for transmitting one or more packets comprising the verification request and/or for transmitting verification information provided by the third-party authentication system. In another embodiment, such a connection may be unsecure.

It will also be appreciated that the information comprised in the verification request, the manner through which the verification request is made, and/or the manner through which the verification request is transmitted to the third-party authentication system may be a function of, among other things, an authentication protocol used by the third-party authentication system. For example, in one embodiment, the third-party authentication system uses an OAuth authentication protocol and the verification request is made and/or transmitted in compliance with standards for the OAuth authentication protocol. In other embodiments, other authentication protocols may be utilized, and thus the information comprised in the verification request and/or the manner through which such information and/or request is transmitted may vary.

At 306 in the example method 300, user access to the private data is granted to the entity if a response to the verification request provides the verification information (e.g., 114 in the example method 100 of FIG. 1), including a third-party access token. That is, stated differently, if the third-party authentication system provides the website (e.g., or an authentication system thereof) with verification information that is configured to (e.g., sufficient to) verify the identity of the entity and/or grant the entity access to the data via the website (e.g., based upon the third-party access token), the website may grant the entity access to the private data that the entity was unable to previously access. As an example, using the third-party access key, the website may verify that the entity has permission from the third party to access the third-party data stored in association with the website, and may grant access the user access to the third-party data via the website (e.g., causing the third-party data to be presented on the website), for example.

It will be appreciated that, as an added security measure, data to which the entity gains access upon the verification may be transmitted to the entity via a secured connection (e.g., HTTPS) and/or an unsecured connection. For example, in one embodiment, upon the verification of the identity of the entity, a secure connection is established between the website and a computing system associated with the entity, and at least a portion of the data transmitted between the website and the computing system may be transmitted via the secure connection. In this way, third-party data may be transmitted via a connection that provides additional security features to protect the data, for example.

It will be appreciated that in one embodiment, the example method 300 may be carried out with the entity having little to no knowledge of the verification that is occurring at 304 and 306. As an example, in one embodiment, the information stored in the computing system associated with the entity may be sufficient to make the verification and/or the entity may not be required to enter additional verification information. Moreover, such verification may occur in real-time as the entity is attempting to access the private data that is presently inaccessible to the entity, and the entity may be unaware that the present access permissions of the entity are insufficient to access such data (e.g., although a computing system associated with the entity may be aware if information is retrieved from the computing system as part of making the verification request).

In another embodiment, as part of making the verification request and/or as part of verifying the identity of the entity (e.g., by the third-party authentication system), the entity may be prompted to enter additional verification information (e.g., such as a password and/or pin number) by the website and/or by the third-party authentication system. Thus, in such an embodiment, the entity may be notified of the verification process and/or may participate in the verification process.

The example method 300 ends at 308.

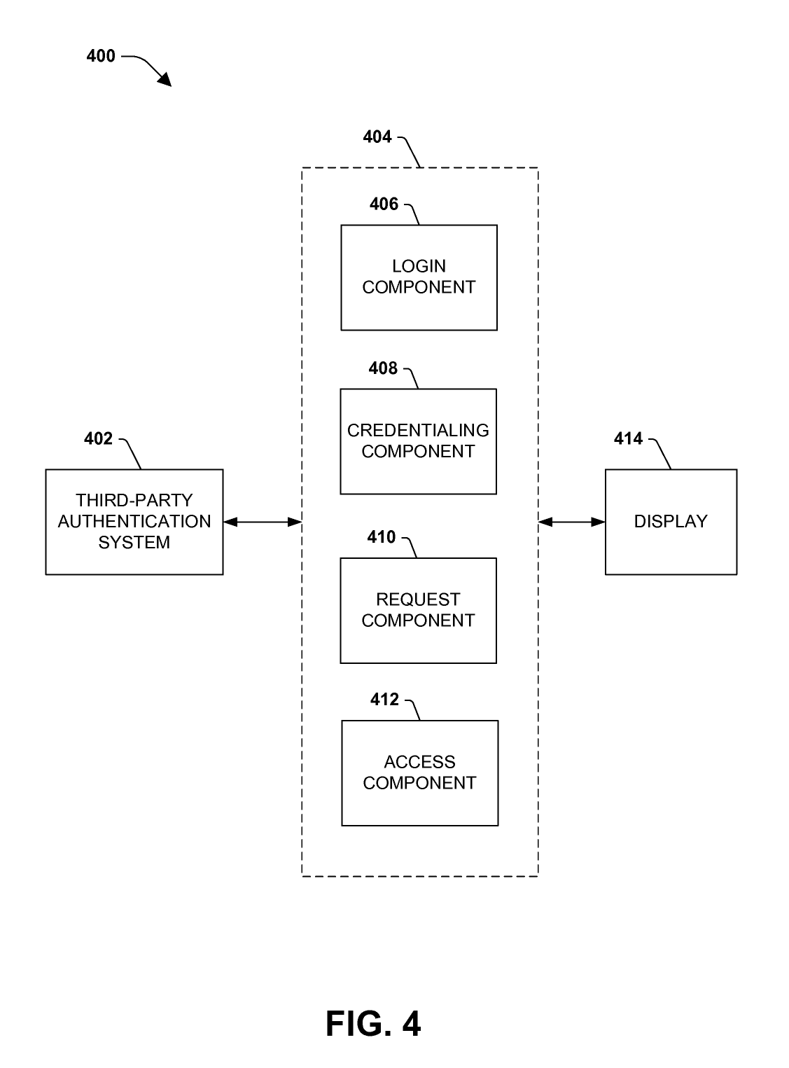

FIG. 4 illustrates an exemplary environment 400 of an example verification system 404 that may be configured to authenticate an entity and/or verify an identity of an entity prior to presenting the entity with private data (e.g., which may be presented on a display 414 of a computing system associated with the entity). More particularly, the example environment 400 illustrates an example system for verifying an identity of an entity via a third-party authentication system 402. As described above, in some applications (e.g., such as where third-party data is accessible via a webpage and/or where an entity is initially logged into a website based upon a third-party authentication), it may be useful to verify the identity of the entity before providing the entity with certain types of data (e.g., such as data related to sensitive information). In this way, an added security measure may be in place to protect against the exposure of private data to an improper entity.

The example system 404 comprises several components that may be utilized to control/limit the flow of private data (e.g., to restrict access to private data unless proper measures have been taken). For example, the example system 404 comprises a login component 406, a credentialing component 408, a request component 410, and/or an access component 412. It will be appreciated that other components may also and/or instead be used to control/limit the flow of private data, and the example system 404 merely comprises some of the many example components that may be used. Moreover, it will be appreciated that the functionality of two or more of the aforementioned components may be combined into a single component and/or the functionality described with respect to a component maybe separated into two or more components.

The login component 406 is configured to login an entity into a website and/or other application (e.g., hereinafter collectively referred to as a “website”) that is configured to provide the entity with access to private data (e.g., sensitive data, secured data, limited data, protected data, etc.). As described above, the login component 406 may log the entity into the website using numerous different login techniques. For example, in one embodiment, the website may comprise its own authentication system, and the entity may authenticate with the website via the authentication system of the website. By way of example, the website may comprise an authentication portion that allows the entity to enter a username and/or password, although other manners of authenticating the entity are also contemplated (e.g., as described above).

In another embodiment, the login component 406 may log the entity into the website based upon an authentication of the entity via the third-party authentication system 402. As an example, an entity may have previously logged into a third-party website associated with the third-party authentication system 402, and the third-party authentication system 402 may have placed an authentication cookie(s) on a computing system associated with the entity. When the entity accesses the website, the login component 406 may (automatically) search the computing system to identify an authentication cookie(s) placed on the computing system by the third-party authentication system 402. If such a cookie(s) exist, the login component 406 may read the authentication cookie(s) and log the entity into the website based at least in party upon the information comprised in the authentication cookie(s).

By way of example, an entity may log into a social networking website by entering access credentials in a field(s) on the social networking website and an authentication system associated with the social networking website (e.g., the third-party authentication system 402) may authenticate the entity by comparing the entered access credentials to stored access credentials. If the entered access credentials substantially match the stored access credentials, access to the social networking website may be granted and the authentication system associated with the social networking website may transmit an authentication cookie to a computing system associated with the entity for storage thereon. Subsequently, if the entity were to navigate to a search engine website, for example, a login component associated with the search engine website (e.g., the login component 406 of the example system 404) may identify the authentication cookie stored on the computing system and may log the entity into the search engine website based upon the authentication cookie provided by the authentication system associated with the social networking website. Thus, the login component 406 may log the entity into the website using its own authentication system and/or using information obtained from a third-party authentication system 402.

The system 404 also comprises a credentialing component 408. The credentialing component 408 is configured to associate access permissions with the entity. As described in more detail with respect to FIG. 1, access permissions are configured to describe what content (e.g., stored in databases associated with the website) the entity may access and/or describe how the entity's access to content is limited (e.g., restricted). Such access permissions may provide for, among other things, whether the entity has permission to read data, to modify data, etc.

The credentialing component 408 may take numerous factors into consideration when determining access permissions to associate with the entity. As an example, the technique used by the login component 406 to log the entity into the website may be taken into consideration when associating access permissions with the entity. For example, an entity that logged into the website via an authentication system of the website may be granted higher-level access permissions than an entity that logged into the website based upon an authentication via a third-party authentication system 402 (e.g., where higher-level access permissions may grant the entity access to more sensitive data relative to the data that the entity may access with low-level access permissions that are associated with the entity by default when the entity logs into the website based upon an authentication via a third-party authentication system 402). In this way, the credentialing component 408 may assign access permissions based upon how confident the credentialing component 408 is with respect to the identity of the entity, for example.

It will be appreciated that the credentialing component may generally provide access permissions merely with respect to data owned by the website (e.g., as opposed to third-party data). Thus, in applications where the website is configured to store and/or provide the entity with data owned by the website and with third-party data (e.g., such as data acquired from the social networking website associated with the third-party authentication system), the credentialing component 408 may, in one embodiment, merely assign access permissions related to the data owned by the website. To acquire access permissions related to the third-party data, the website may issue a verification request seeking access permissions (e.g., an access token) from a third-party that owns the third-party data as described with respect to FIG. 3 (e.g., prior to providing the entity with access to the third-party data), for example. In another embodiment, the credentialing component 408 may associate access permissions with an entity in a manner that allows the entity to access the third-party content (e.g., without first acquiring access permissions from the third-party).

The example system 404 also comprises a request component 410 configured to make a verification request to the third-party authentication system 402. The verification request is configured to request verification information about the entity so that the system 404 (e.g., or an access component 412 of the system 404) can grant the entity access to private data to which the entity was not granted access upon the initial login by the login component 406. For example, an access request may be received by the system 404 requesting access to third-party data and/or to data that is inaccessible to the entity given the access permissions presently associated with the entity. Thus, the request component 410 (e.g., which may be operably coupled to the access component 412 and/or the credentialing component 408 to identify instances when the entity does not have permission to access data) is configured to be in operable communication with the third-party authentication system 402 (e.g., over a network), to determine whether the third-party authentication system 402 has sufficient knowledge about the entity to verify the identity of the entity so that the credentialing component 408 can increase/alter access permissions of the entity.

As described above with respect to FIGS. 2 and 3, the content of the verification request and/or the information that is being request may depend upon, among other things, the type of data that is the website is attempting to gain access to for the entity. For example, in one embodiment, where the entity was logged into the website based upon an authentication cookie(s) provided by the third-party authentication system 402, the website may attempt to verify an identity of the entity before providing access to some website-owned data (e.g., to protect the data from being provided to an imposter). In such an embodiment, the request component 410 may provide the third-party authentication system 402 with information that may be used by the third-party authentication system 402 to re-authenticate the entity and/or to verify that the content of the authentication cookie(s) stored on the computing system associated with the entity matches the content of the authentication cookie(s) that the third-party authentication system 402 created (e.g., that was used to log the entity into the website by the login component 406).

In another embodiment, where the website is attempting to gain access to third-party data (e.g., stored in association with the website), the verification request 410 may merely comprise a request for a third-party access key (e.g., detailing access permissions for the third-party data) and/or information that is sufficient to identify the entity (e.g., such as a username of the entity). However, the third-party authentication system 402 may request additional content from the request component 410 to protect the third-party data from being inadvertently provided to an entity not intended to have access to the third-party data. For example, the third-party authentication system 402 may request to view that authentication cookie(s) that was used to log the entity into the website (e.g., if the authentication cookie(s) was provided by the third-party authentication system 402) so that the third-party authentication system 402 can compare the authentication cookie(s) to its own data to verify the identity of the entity.

Thus, information comprised in the verification request made by the request component 410 and/or the request(s) made in the verification request may be a function of, among other things, specifications of the third-party authentication system 402 to verify an identity of the entity, the type of data to which the website is attempting to provide the entity with access, and/or the login technique used to log the entity into the website, for example.

It will be appreciated that upon receipt of the requested verification information (e.g., access token, identity confirmation indication, etc.) by the request component 410, the credentialing component 408 may alter the access permissions associated with the entity. For example, the credentialing component 408 may alter the access permissions associated with the entity from low-level access permissions to higher-level access permissions so that the entity can access content that was inaccessible by the entity given the low-level access permissions. Moreover, where an access token is received from the third-party authentication system 402, the credentialing component 408 may store the access key in association with the entity so that the entity may access third-party data (e.g., as specified in the access token).

The example system 404 also comprises an access component 412 configured to provide the entity with access to the website-owned and/or third-party owned content based at least in part upon the access permissions associated with the entity and/or based upon, in response to the verification request, receipt of the requested verification information (e.g., the access token, the identity verification, etc.). Thus, in essence, the access component 412 is configured to compare the access permissions as presently associated with the entity (e.g., after the response to the verification request has been received) to access permissions that are specified (e.g., required) to access the private data specified in an access request. If the entity is associated with access permissions that substantially match and/or exceed the specified access permissions, the entity may be granted access to the data. If the entity does not have sufficient access permissions, the access component 412 may notify the request component 410 and/or the credentialing component 408 to determine whether access permissions can be altered to acquire access to the data requested by the access request (e.g., by verifying the identity of the entity with the third-party authentication system 402, prompting the entity for additional authentication information, etc.). In this way, the system 404 attempts to provide the entity with access to requested data while providing a safe environment for storing data and/or protecting the contents of the data, for example.

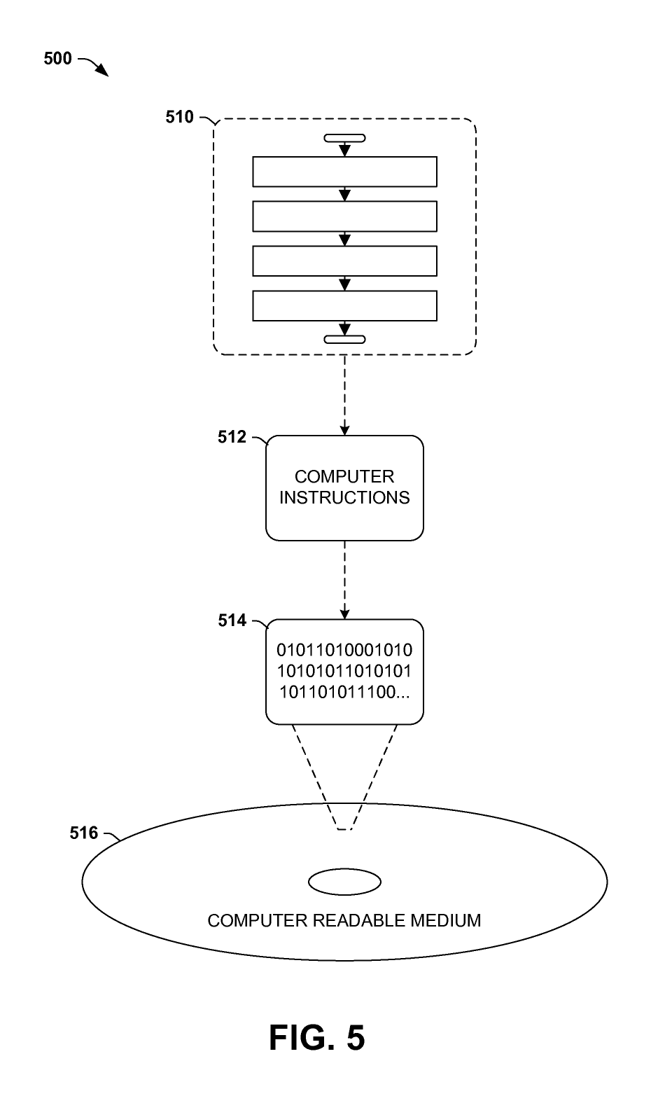

Still another embodiment involves a computer-readable medium comprising processor-executable instructions configured to implement one or more of the techniques presented herein. An exemplary computer-readable medium that may be devised in these ways is illustrated in FIG. 5, wherein the implementation 500 comprises a computer-readable medium 516 (e.g., a CD-R, DVD-R, or a platter of a hard disk drive), on which is encoded computer-readable data 514. This computer-readable data 514 in turn comprises a set of computer instructions 512 configured to operate according to one or more of the principles set forth herein. In one such embodiment 500, the processor-executable computer instructions 512 may be configured to perform a method 510, such as at least some of the exemplary method 100 of FIG. 1, at least some of the exemplary method 200 of FIG. 2, and/or at least some of the exemplary method 300 of FIG. 3, for example. In another such embodiment, the processor-executable instructions 512 may be configured to implement a system, such as at least some of the exemplary system 400 of FIG. 4, for example. Many such computer-readable media 516 may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

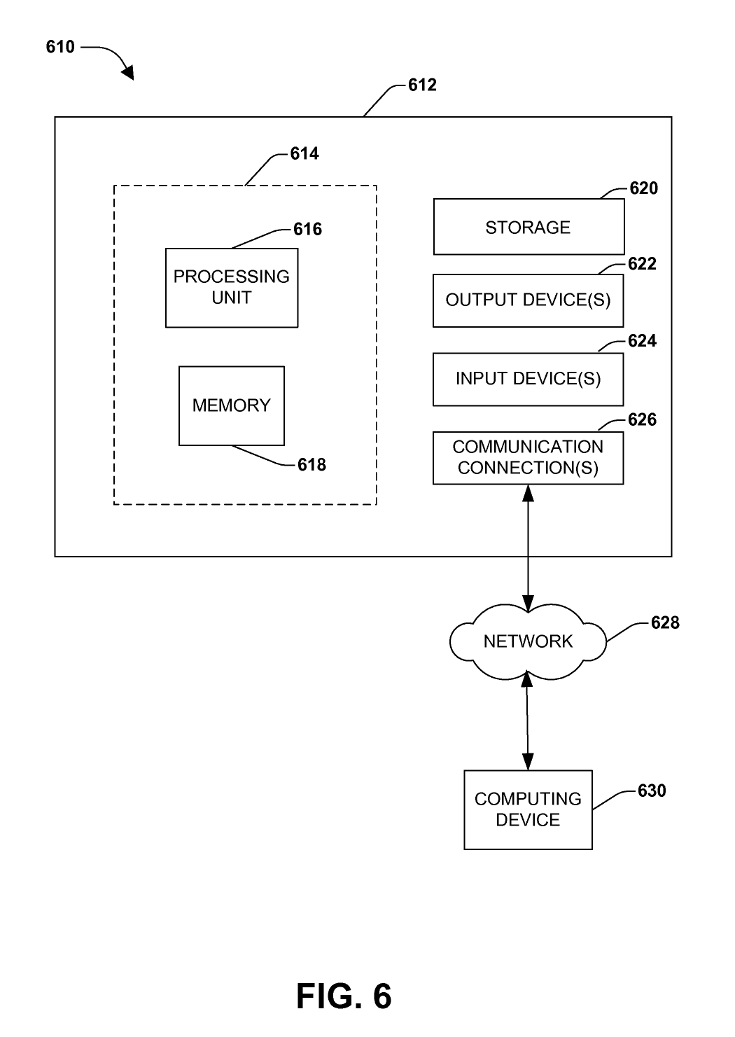

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 610 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example), or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via a network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B or the like generally means A or B or both A and B.

Although the disclosure has been shown and described with respect to one or more implementations, equivalent alterations and modifications will occur to others skilled in the art based at least in part upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for verifying an identity of an entity via a third-party authentication system, comprising:
making a verification request to the third-party authentication system for verification information about the entity to access private data requested by the entity; and
granting the entity access to the private data if a response to the verification request, from the third-party authentication system, provides the verification information.

2. The method of claim 1, comprising:
receiving an access request requesting access to the private data; and
determining whether the entity has permission to access the private data.

3. The method of claim 2, making the verification request to the third-party authentication system comprising making the verification request to the third-party authentication system when it is determined that the entity does not have permission to access the private data.

4. The method of claim 1, the verification information comprising a third-party access token.

5. The method of claim 1, the private data comprising third-party data associated with the third-party authentication system and stored in a database associated with a second entity making the verification request.

6. The method of claim 5, the verification information comprising a third-party access token that is configured to cause the private data to be accessible to the entity.

7. The method of claim 1, the verification request comprising a request for the third-party authentication system to reevaluate an authentication cookie associated with the entity.

8. The method of claim 1, comprising:
logging the entity into a website associated with a second entity making the verification request based upon login information supplied by the third-party authentication system, logging the entity into the website comprising granting the entity low-level access permissions to access data stored in association with the website; and
receiving an access request requesting access to the private data, stored in association with the website, that the entity cannot access with the low-level access permissions.

9. The method of claim 8, granting the entity access to the private data if the response to the verification request provides the verification information comprising granting the entity higher-level access permissions to access the private data.

10. The method of claim 1, granting the entity access to the private data comprising establishing a secure connection between the entity and a database comprising the private data.

11. The method of claim 1, the third-party authentication system comprising an authentication system for accessing a third-party social networking website.

12. The method of claim 1, the private data stored on a database associated with a search engine website.

13. A verification system for verifying an identity of an entity via a third-party authentication system, comprising:
a request component configured to make a verification request to the third-party authentication system for verification information about the entity to access private data requested by the entity; and
an access component configured to grant the entity access to the private data if a response to the verification request, from the third-party authentication system, provides the verification information.

14. The system of claim 13, comprising a login component configured to log the entity into a website associated with an entity storing the private data, the login component configured to log the entity into the website based upon login information supplied via the third-party authentication system.

15. The system of claim 13, comprising a credentialing component configured to associate the entity with access permissions.

16. The system of claim 15, the access component configured to grant the entity access to the private data when the credentialing component associates higher-level access permissions with the entity, and the request component configured to generate the verification request when the entity attempts to access the private data while associated with low-level access permissions.

17. The system of claim 15, the credentialing component configured to associate low-level access permissions with the entity upon an initial login and to associate higher-level access permissions with the entity upon being provided with the verification information, the access component configured to grant the entity access to the private data based at least in part upon the higher-level access permissions being associated with the entity.

18. The system of claim 13, the private data comprising third-party data associated with the third-party authentication system and the verification information comprising an access token for granting the entity access to the private data.

19. The system of claim 13, the third-party authentication system utilized for logging the entity into a social networking website and the private data stored in a database associated with a search engine website.

20. A computer-readable medium comprising computer executable instructions that when executed via a processor perform a method, the method comprising:
making a verification request to the third-party authentication system for verification information about the entity to access private data requested by the entity; and
granting the entity access to the private data if a response to the verification request, from the third-party authentication system, provides the verification information.
